(19) United States
(12) Patent Application Publication
(10) Pub. No.: US 2008/0222440 A1
(43) Pub. Date: Sep. 11, 2008

(54) Real time clock calibration system

(76) Inventors: Stephen Jones, Swindon (GB); Rupinder Judge, Bracknell (GB)

Correspondence Address: DUANE MORRIS, LLP, 968 POSTAL ROAD, SUITE 110, P.O. BOX 90400, ALLENTOWN, PA, 18109-0400, US

(21) Appl. No.: 11/715,182

(22) Filed: Mar. 7, 2007

(51) Int. Cl. G06F 1/12

(52) U.S. Cl. 713/400

(57) ABSTRACT

A temperature-based real time clock calibration system and method for performing the same. The system in one embodiment includes a real time clock calibrated against a reference frequency, a temperature sensor being operative to measure a instantaneous temperature T1, and control circuitry operative to receive and sense the temperature T1. Control logic, preferably implemented in the control circuitry in one embodiment, determines when to recalibrate the real time clock against the reference frequency based on the measured temperature T1. In one embodiment, the reference frequency is generated by a main system clock. The system may be used during sleep mode or another reduced power operating mode of an electronic device.

### FIELD OF THE INVENTION

The present invention generally relates to mobile telecommunication devices, and more particularly to systems and methods for providing a real time clock suitable for use in telecommunication devices.

### BACKGROUND

Microprocessor-based systems employed in mobile telecommunication devices such as mobile cellular handsets or phones include a high quality, highly accurate main system clock (i.e., frequency generator or oscillator) that generates an electrical signal having a very precise predefined frequency. The clock signal is used to synchronize and coordinate the operations of various circuits and components in the handset. Cellular networks for wireless digital telecommunications, such as GSM (Global System for Mobile communications) for example, set exacting specifications for network protocols. Therefore, highly accurate frequency generators such as the main system clock are used to meet these specifications and are typically synchronized with the communication network.

The drawback of a main system clock (“MSC”), however, is that it operates on a relatively large current and hence consumes a lot of power. This shortens battery life which is important to the consumer. To conserve battery life when the mobile phone is not in use, the operating system will typically put the phone into a sleep or idle mode to reduce power consumption by temporarily deactivating non-essential functions and processing routines that are not needed for standby operation. As a common example, the visual display may be completely turned off or image data reduced to a minimum (e.g., time display only) when the phone is in sleep mode. The phone typically stays in this low-power state until a qualified interrupt event occurs triggering the phone's normal full power mode to be reactivated.

As another power conserving measure implemented during sleep mode, the main system clock is temporarily disabled and the time reference is alternatively switched to a lower frequency 32 kHz crystal-based frequency generator or real time clock (“real time clock” or “RTC” hereafter) that significantly reduces power consumption. A real time clock essentially is an electronic circuit having a vibrating crystal made from a piezoelectric material that generates an electrical signal with a predefined frequency (e.g., 32 kHz in this instance). The lower frequency real time clock consumes less power than the main system clack (saving on the order of up to about 2 mA of current in some instances), but is sufficient to keep executing instructions, track time, and run peripherals and operations that are frequency dependent. However, the frequency accuracy of the generally inexpensive real time clocks (in contrast to main system clocks) is not necessarily sufficient to guarantee the specified system timing and synchronization without a periodic recalibration of the real time clock against the more accurate main system clock. The inaccuracy results from the fact that the real time clock accuracy varies as the crystal ages, and more problematically, accuracy is highly sensitive to or dependent on operating temperature. The frequency versus temperature characteristic of the real time clock is parabolic with a turning point (zero gradient) at approximately room temperature. Therefore, slight temperature increases by only as much as a few degrees in some instances may adversely affect the accuracy of the real time clock. Such temperature swings may be produced by incoming calls which generate circuit heat, environmental conditions such as fluctuating ambient temperatures, or other reasons.

For the foregoing reasons, the real time clock is calibrated against a reference frequency each time before the phone initially enters the sleep mode. Preferably, the real time clock is conveniently calibrated against the main system clock which generates the relevant reference frequency. Even during sleep mode, however, the phone still wakes up periodically to “listen” to the network for any incoming calls. This checking operation is typically performed every ½ to 2 seconds. Although the phone may only awaken for milliseconds to check the network for calls, the real time clock nonetheless is recalibrated during these mini-wakeup events even though there may not be any change in operating temperature of the phone. The cumulative effect of the recalibration step, which in some instances may be completely unnecessary if no change in temperature has occurred, is that it reduces the time that the phone could be in sleep mode (since the calibration step takes time), increases average power consumption, and therefore reduces battery life and standby time.

An improved system for initiating calibration of the real time clock is desired.

### SUMMARY

In some embodiments, a real time clock calibration system for an electronic device includes: a real time clock calibrated against a reference frequency; a first temperature sensor operative to measure an instantaneous actual temperature T1; control circuitry operative to sense the temperature T1; and control logic implemented in the control circuitry. The control logic in a preferred embodiment is operative to determine when to recalibrate the real time clock against the reference frequency based on the measured temperature T1.

According to another embodiment, an electronic device with a real time clock calibration system generally includes: a device housing; a microprocessor including a main system clock that generates an electrical signal having a frequency; and a real time clock that is operative to be calibrated against the main system clock, the real time clock having an initial calibration and associated initial calibration temperature T_{CT}; at least one temperature sensor being operative to measure an instantaneous actual temperature T1 in the housing; and control circuitry being operative to receive a first temperature signal indicative of initial calibration temperature T_{CT} and a second temperature signal indicative of the instantaneous temperature T1. Preferably, the control circuit includes control logic implementing a routine using temperatures T_{CT} and TI to determine when to recalibrate the real time clock.

According to another embodiment, a real time clock calibration system for an electronic device includes: a real time clock calibrated against a reference frequency; a temperature sensor located in the device and operable to measure an instantaneous actual temperature T1 associated with the device; and means for determining when to recalibrate the real time clock against the reference frequency based on the instantaneous actual measured temperature T1.

According to another embodiment, a method of recalibrating a real time clock includes the steps of: calibrating a real time clock in an electronic device having a housing; measuring a first temperature associated with the housing; reading the first temperature into control logic implemented by a control circuit; comparing the first temperature to a second reference temperature, and recalibrating the real time clock based on the comparison of the first temperature to the second reference temperature.

According to another embodiment, a method of recalibrating a real time clock includes the steps of: initiating sleep mode operation for the electronic device; switching frequency control for the electronic device from a main system clock to a real time clock that consumes less power than the main system clock; calibrating initially the real time clock against the main system clock; measuring an initial calibration temperature essentially concurrently with calibrating the real time clock; measuring subsequently a sleep mode operating temperature for the electronic device after measuring the initial calibration temperature of the real time clock; comparing the sleep mode operating temperature to the initial calibration temperature; and recalibrating the real time clock if the sleep mode operating temperature is greater than or less than the initial calibration temperature by a predetermined temperature differential limit.

### BRIEF DESCRIPTION OF THE DRAWINGS

The features of the preferred embodiments will be described with reference to the following drawings where like elements are labeled similarly, and in which:

FIG. 1 is a schematic diagram of an intelligent real time clock (RTC) calibration system according to one embodiment; and

FIG. 2 is a flowchart showing exemplary control logic for the RTC calibration system of FIG. 1.

All drawings are schematic and are not drawn to scale.

### DETAILED DESCRIPTION

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

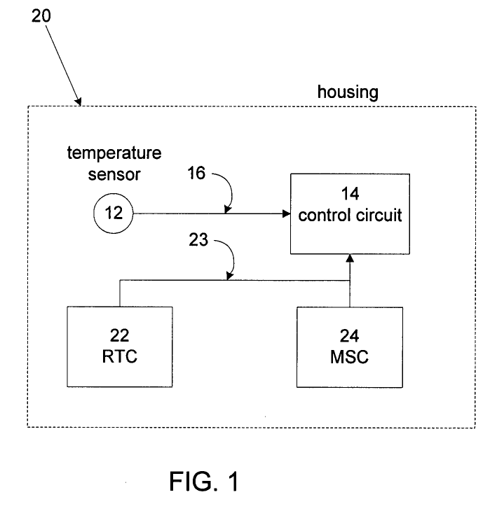

Referring to FIG. 1, an exemplary real time clock (RTC) automatic calibration system 10 for an electronic device generally includes RTC 22; a main system clock (MSC) 24; at lease one temperature sensing probe 12; a control circuit/circuitry 14, and data communication links 16, 23 to transmit/exchange data, control commands, and signals electronically between the probe, control circuitry, RTC, and MSC. The data communication links 16, 23 may include without limitation wireless, wired, “on-board” (circuit board) conductors, and combinations thereof. In a preferred embodiment, a 32 kHz RTC with a nominal crystal operating temperature of 25 degrees C is used. Control circuitry 14 preferably is part of a microprocessor-based system used to operate the electronic device. RTC 22 and associated calibration system 10 may be disposed in a housing 20 that contains and supports the electronic device components, which in some embodiments may be a mobile wireless telecommunication device such as a phone or handset, PDA (personal digital assistant), pager, or Blackberry®-type device that communicate with an external system. In a preferred embodiment, the RTC calibration system is used in a mobile cellular phone or handset. It will be appreciated, however, that the invention is not limited in its applicability to any particular type of electronic or telecommunication device. Accordingly, some embodiments may be handheld or non-handheld devices having wireless or wired data communication links to an external system (e.g., personal computers connected to a local area network (LAN) via Ethernet cables). Accordingly, any type of electronic device having an RTC may be used.

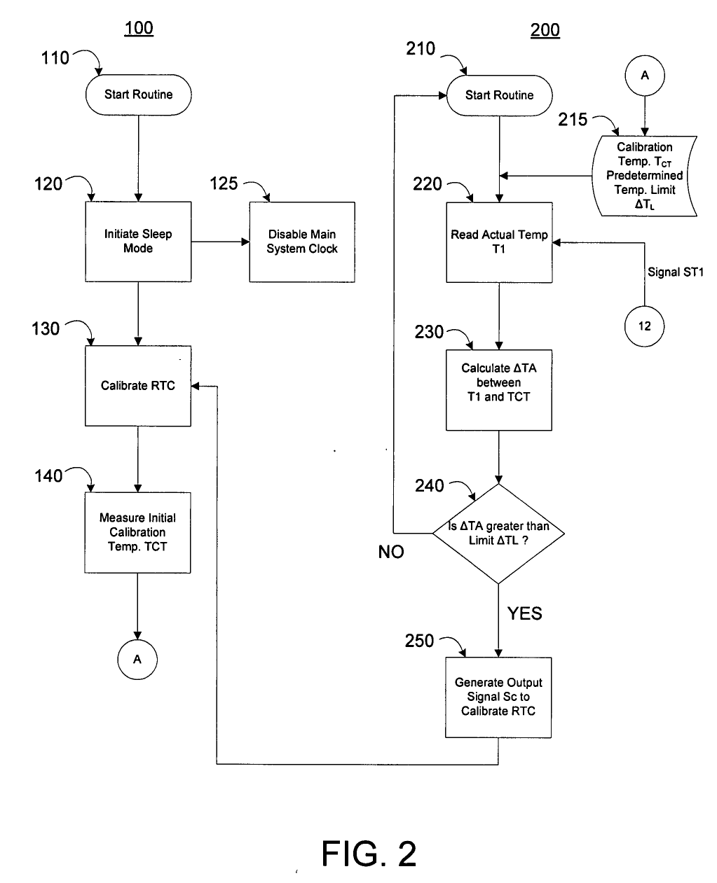

Referring to FIG. 1, temperature sensor 12 is operative to measure an instantaneous actual temperature T1 at any given time in the electronic device housing to which RTC 22 is exposed. Accordingly, the location of temperature sensor 12 in housing 20 preferably is selected so that the sensor is either proximate the location of RTC 22 in the housing and/or measures an actual temperature T1 elsewhere in the housing that represents the same temperature that will be experienced by the quartz oscillator of the RTC, thereby affecting the clock's accuracy. In a preferred embodiment, sensor 12 is further operative to generate an electrical signal S_{T1} (see FIG. 2) which is indicative of the instantaneous actual measured environmental temperature T1 for reasons explained further herein. Signal S_{T1} is transmitted to and received by control circuit 14 allowing the circuit to sense measured temperature T1. Preferably, in one embodiment, sensor 12 continuously monitors temperature T1 during at least the entire time that the electronic device is in sleep mode, also as further explained herein.

Temperature sensor 12 may be any commercially-available type sensor, such as without limitation a thermistor, thermocouple, resistance temperature detector (RTD), or other device which generates an output voltage signal S_{T1} that is indicative of the actual measured temperature T1 and can be converted by calibration control circuit 14 into a corresponding temperature value for further analysis. In some embodiments, temperature sensor 12 may be an independent component being dedicated for use with the automatic calibration system 10. In many portable telecommunication devices such as cellular phones, handset temperatures are already monitored via a temperature sensor. In some other preferred embodiments, therefore, an existing temperature sensor may be used to provide a temperature signal to automatic calibration system 10 for economy and efficiency in both system costs and physical space conservation.

Referring to FIGS. 1 and 2, in one embodiment, temperature sensor 12 is further operative to measure the actual temperature T_{CT} in the electronic device housing 20 at essentially the same time that RTC 22 is initially calibrated against MSC 24 at the beginning of a reduced power mode of operation in the device, such as sleep mode. Sensor 12 is further operative to generate an electrical signal S_{TC} (see FIG. 2) which is indicative of the initial calibration temperature T_{CT} for reasons explained further herein. Signal S_{TC} is transmitted to and received by control circuit 14 allowing the circuit to sense measured temperature T_{CT}. Temperature T_{CT} represents a historic or reference temperature which in a preferred embodiment is used by control circuit 14 and control logic to determine when to recalibrate RTC 22, as further explained herein.

Calibration control circuitry 14 is operative to receive temperature signals S_{T1} from sensor 12 via data communication link 13, sense actual temperatures T1 measured in housing 20 by sensor 20, and analyze temperature signal S_{T1} against a set of preprogrammed and learned variables and values to determine when to recalibrate RTC 22 during sleep mode operation. Control circuitry 14 thus preferably includes and implements associated control logic that is preprogrammed into the circuitry and operative to automatically determine when RTC 22 requires calibration based on temperature. The distance-voltage conversion control logic may be implemented in hardware, firmware, software, or any combination thereof. Accordingly, the terms “circuitry” or “circuit” as used herein means any combination of hardware, firmware, or software used to implement the control logic, and/or to process control or power signals. The terms “circuitry” and “circuit” further are used interchangeably herein.

A preferred method of calibrating a RTC using a temperature-based calibration control system 10 will now be described with reference to FIGS. 1 and 2. FIG. 2 shows preferred exemplary control logic 200 preferably preprogrammed into and implemented by calibration control circuitry 14 for directing the recalibration timing of RTC 22. Control logic 200 complements a control logic process 100 that initiates the calibration of RTC 22 when the electronic device initially enters sleep mode. Logic process 100 may also be preprogrammed into and implemented by control circuitry 14 or by another part of the microprocessor based system that controls the functions of the electronic device. The control logic will be explained using a non-limiting example of an electronic device in the form of a cellular mobile handset for convenience only. However, it will be appreciated as noted herein that any type of electronic device having an RTC may be used.

Referring to FIG. 2, control logic process 100 begins with step 110 in which the routine is started. In step 120, the control logic initiates sleep mode operation for the handset, which in some embodiments may include a timer circuit that triggers the handset to enter sleep mode when a preprogrammed time limit of inactivity is exceeded. Step 120 triggers step 125 in which the main system clock 24 is temporarily disabled or shut down. In step 130, control logic initiates the calibration of RTC 22 against the main system clock upon the handset first entering sleep mode. Control passes to step 140 in which an actual initial calibration temperature T_{CT} is concurrently measured and recorded at essentially the time that the initial sleep mode calibration of RTC 22 is performed in step 130. Initial calibration temperature T_{CT} may be measured by temperature sensor 12 or a different temperature sensor. A control signal is then generated by control logic step 140 that contains is indicative of actual calibration temperature T_{CT} (reference A, FIG. 2), which is communicated to control logic process 200.

With continuing reference to FIG. 2, control logic process 200 starts with step 210 that initiates the routine. In step 215, control logic 200 receives and is preprogrammed with actual calibration temperature T_{CT} which has been transmitted by control logic process 100 (reference A, FIG. 2) and is stored in control circuit 14 or suitable electronic memory device or database accessible to logic process 200. Also in step 215, control logic 200 has preferably been preprogrammed with a predetermined differential temperature limit ΔT_{L} which defines a theoretical acceptable maximum temperature difference between the actual measured temperature T₁ and initial calibration temperature T_{CT} (measured in step 140 of logic process 100). In some non-limiting embodiments, a typical illustrative maximum ΔT_{L} may preferably be set in a range from about 0.5 to 10 degrees C. or F., and more preferably in some embodiments from about 1 to at 2 degrees C. or F. A maximum acceptable theoretical differential temperature limit ΔT_{L} may be based on a threshold level which if ΔT_{L} is exceeded, the frequency accuracy of RTC 22 may adversely be affected such that the mobile handset may fail to meet the accuracy specifications of a given particular cellular standard being used by the communication network to which the handset is connected. It is well within the ambit of those skilled in the art to determine an appropriate temperature differential limit ΔT_{L} based on the particular network communication standard being used and the particular characteristics and properties of the actual manufacturer's RTC selected for use in the handset. In some instances, ΔT_{L} may be determined with the assistance of empirical data collection.

With continuing reference to FIG. 2, logic process 200 continues with step 220 in which the actual instantaneous temperature T1 of the mobile handset is sensed or detected by control circuitry 14 via data communication link 16 and received by the control logic. Temperature sensor 12 preferably continuously monitors temperature T1 and generates a signal S_{T1} (which represents actual measured temperature T1) that is received by control circuitry 14 and read in step 220. Using the instantaneous actual handset temperature T1, control passes to step 230 in which a temperature differential ΔT_{A} is calculated between instantaneous actual temperature T1 and initial calibration temperature T_{CT} by comparing the two temperatures. In step 240, a test is performed to determine whether temperature differential ΔT_{A} calculated in step 230 is greater than an acceptable differential temperature limit ΔT_{L} that has been preprogrammed into the control logic. If ΔT_{A} is less than or equal to ΔT_{L} (i.e., a “NO” response is returned), RTC 22 does not require recalibration and control is returned to step 210 to start logic routine 200 again. If ΔT_{A} is greater than ΔT_{L} (i.e., a “YES” response is returned), RTC 22 should be recalibrated since its accuracy may not meet the acceptable frequency accuracy standards for the mobile handset. Therefore, control passes to step 250 which is executed. In step 250, a control signal is generated and transmitted to step 130 in control logic process 100 to recalibrate RTC 22 against the main system clock so that the frequencies will match. RTC 22 is then recalibrated against the main system clock 24 under the control of control circuitry 14 via data communication link 23.

While the foregoing description and drawings represent preferred or exemplary embodiments of the present invention, it will be understood that various additions, modifications and substitutions may be made therein without departing from the spirit and scope and range of equivalents of the the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes and/or control logic as applicable described herein may be made without departing from the spirit of the invention. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A real time clock calibration system for an electronic device comprising:
a real time clock calibrated against a reference frequency;
a first temperature sensor operative to measure an instantaneous temperature T1;
control circuitry operative to sense the temperature T1; and
control logic implemented in the control circuitry and being operative to determine when to recalibrate the real time clock against the reference frequency based on the measured temperature T1.

2. The real time clock calibration system of claim 1, wherein an initial calibration temperature T_{CT} of the real time clock is measured and received by the control circuitry, the control logic being further operative to use the initial calibration temperature to determine when to recalibrate the real time clock.

3. The real time clock calibration system of claim 2, further comprising the control logic being operative to calculate a temperature differential ΔT_{A} between the initial calibration temperature T_{CT} and the instantaneous temperature T1, wherein the real time clock is recalibrated if the difference ΔT_{A} is greater than a predetermined differential temperature limit ΔT_{L} that has been preprogrammed into the control logic.

4. The real time clock calibration system of claim 1, further comprising the control logic being operative to generate a signal to initiate recalibration of the real time clock.

5. The real time clock calibration system of claim 1, wherein the reference frequency is generated by a main system clock.

6. The real time clock calibration system of claim 5, wherein the real time clock is recalibrated against the main system clock.

7. The real time clock calibration system of claim 1, wherein the control circuit senses the temperature T1 during sleep mode operation of an electronic device.

8. The real time clock calibration system of claim 7, wherein the electronic device is a mobile handset.

9. The real time clock calibration system of claim 1, wherein the real time clock is disposed in an electronic device.

10. The real time clock calibration system of claim 9, wherein the electronic device is a mobile telecommunication handset.

11. The real time clock calibration system of claim 1, wherein the control logic is implemented in hardware, firmware, software, or a combination thereof.

12. The real time clock calibration system of claim 1, wherein the real time clock is a 32 kHz crystal oscillator.

13. An electronic device with a real time clock calibration system comprising:
a device housing;
a microprocessor including a main system clock;
a real time clock being operative to be calibrated against the main system clock, the real time clock having an initial calibration and associated initial calibration temperature T_{CT};
at least one temperature sensor being operative to measure an instantaneous temperature T1 in the housing;
control circuitry being operative to receive a first temperature signal indicative of the initial calibration temperature T_{CT} and a second temperature signal indicative of instantaneous temperature T1, the control circuit including control logic implementing a routine using temperatures T_{CT} and T1 to determine when to recalibrate the real time clock.

14. The electronic device of claim 13, further comprising the control logic being operative to calculate a temperature differential ΔT_{A} between the initial calibration temperature T_{CT} and the instantaneous temperature T1, wherein the real time clock is recalibrated if the difference ΔT_{A} is greater than a predetermined differential temperature limit ΔT_{L} that has been preprogrammed into the control logic.

15. The electronic device of claim 13, further comprising the control logic being operative to generate a signal to initiate recalibration of the real time clock.

16. The electronic device of claim 13, wherein the control circuit senses the temperature T1 during a reduced power mode of operation of the electronic device.

17. The electronic device of claim 13, wherein the electronic device is a mobile telecommunication handset.

18. A real time clock calibration system for an electronic device comprising:
a real time clock calibrated against a reference frequency;
a temperature sensor located in, on or proximate to the device and operable to measure an instantaneous actual temperature T1 associated with the device; and
means for determining when to recalibrate the real time clock against the reference frequency based on the measured temperature T1.

19. The real time clock calibration system of claim 18, wherein the recalibration means includes control circuitry being operative to receive a temperature signal generated by the temperature sensor that is indicative of the actual temperature T1, the control circuit including control logic implementing a routine using temperature T1 to determine when to recalibrate the real time clock.

20. The real time clock calibration system of claim 19, wherein the control logic compares instantaneous temperature T1 to a historic calibration temperature T_{CT} measured and recorded for the real time clock.

21. The real time clock calibration system of claim 18, wherein the recalibration means includes control circuitry being operative to receive a temperature signal generated by the temperature sensor that is indicative of the instantaneous temperature T1, the control circuit including control logic implementing a routine to calculate a temperature differential ΔT_{A} between instantaneous temperature T1 and an initial calibration temperature T_{CT} for the real time clock, the control logic further comparing calculated temperature differential ΔT_{A} to a theoretical temperature differential limit ΔT_{L} that is preprogrammed into the control logic for determining when to recalibrate the real time clock.

22. A method of recalibrating a real time clock comprising:
calibrating a real time clock in an electronic device having a housing;
measuring a first temperature associated with the housing;
comparing the first temperature to a second reference temperature, and
recalibrating the real time clock based on the comparison of the first temperature to the second reference temperature.

23. The method of claim 22, wherein the real time clock is recalibrated if the first temperature is greater than or less than the second temperature by a predetermined temperature differential limit programmed into the control logic.

24. The method of claim 22, wherein the second reference temperature is a housing temperature measured essentially concurrently with calibrating the real time clock.

25. The method of claim 23, wherein the second reference temperature is an initial calibration temperature measured at the start of a sleep mode operating condition of the electronic device.

26. The method of claim 22, wherein calibrating of the real time clock occurs at the start of a sleep mode operating condition of the electronic device.

27. The method of claim 22, further comprising a step of measuring a housing temperature at the time the calibration step is performed which represents the second reference temperature, the first temperature being measured after the calibration step is performed.

28. The method of claim 22, further comprising a step of generating an output signal to initiate the recalibrating step.

29. The method of claim 22, wherein the electronic device is a mobile telecommunication device.

30. The method of claim 22, wherein real time clock is a 32 kHz quartz oscillator.

31. A method of recalibrating a real time clock during a sleep mode operating condition of an electronic device having a microprocessor, the method comprising:
initiating sleep mode operation for the electronic device;
switching frequency control for the electronic device from a main system clock to a real time clock that consumes less power than the main system clock;
calibrating initially the real time clock against the main system clock;
measuring an initial calibration temperature essentially concurrently with calibrating the real time clock;
measuring a sleep mode operating temperature for the electronic device after measuring the initial calibration temperature of the real time clock;
comparing the sleep mode operating temperature to the initial calibration temperature; and
recalibrating the real time clock if the sleep mode operating temperature is greater than or less than the initial calibration temperature by a predetermined temperature differential limit.

32. The method of claim 31, wherein the steps of measuring the initial calibration and sleep mode operating temperatures both include using a temperature sensor disposed in a housing for the electronic device.

33. The method of claim 31, wherein the comparing step is performed by control logic implemented by a control circuit.

34. The method of claim 33, wherein the control logic is implemented in hardware, firmware, software, or a combination thereof associated with the electronic device.
